(19) United States
(12) Patent Application Publication
(10) Pub. No.: US 2008/0175106 A1
(43) Pub. Date: Jul. 24, 2008

(54) Chronometric display means

(76) Inventor: Michael Vikesland, Dripping Springs, TX (US)

Correspondence Address: Christopher J. Whewell;Western Patent Group, 6020 Tonkowa Trail, Georgetown, TX, 78628, US

(21) Appl. No.: 11/656,028

(22) Filed: Jan. 22, 2007

(51) Int. Cl. G04C 19/00

(52) U.S. Cl. 368/83; 368/82; 368/84

(57) ABSTRACT

Provided herein is a display means for indicating time of day to an observer. A display according to the invention uses a minimal number of indicators, which are arranged in a first row having twelve indicators, and a second row containing eleven indicators. A display means according to the invention provides time of day to the nearest five-minute interval. Also provided a process for displaying the time of day to the nearest five minutes.

### TECHNICAL FIELD

This invention relates generally to the field of the display of the time of day. More particularly, it relates to devices and methods useful for displaying time.

### BACKGROUND

In addition to the five human senses of smell, taste, touch, hearing, and sight, man also has another sense, that of time, which is likely not conceived by the lesser animals. Indeed, it is man's sense of time which enables planning and encourages creative thought processes. Thus, the development of means for measuring and displaying time has always been the mark of advanced societies, with early temples and other structures useful for measuring the positions of the stars and planets being prime examples of early means for time measurement.

In more modem times, the Europeans and most notably the Swiss, became famous for their crafting of various sorts of timepieces, including decorative cuckoo clocks, and highly-accurate personal timepieces, including wrist and pocket watches. More recently, the Japanese have increased the popularity of LED-operated and digital means for displaying time by their dynamic methods of manufacturing cost reduction. At present, the market for personal timepieces is dominated by wristwatches, which are made by a wide range of manufacturers in scores of countries, in various shapes and colors, and comprised of various materials ranging from inexpensive polyolefins all the way up to precious metals laced with prized gemstones, sometimes in high-fashion designs and configurations.

Many timepieces in popular use in general have used the same analog means for displaying time for centuries, which employs an hour hand and a minute hand, as displayed on the famous “Big Ben” in London, which means is well-known in the art. Another means for displaying time in popular use is the display of the time itself in numerical fashion, by light-emitting diodes or by liquid-crystal displays. Such means directly displays the time in the form of, for example: “10:36”. These two means, the analog and digital means for display of time, probably account for over 90% of the means for display of time currently in public use.

Crafty workers and designers have been busy conceiving and producing alternative means for display of time, and the prior art is replete with many alternate methods and designs. These include the disclosures of U.S. Pat. Nos. 3,750,384; 3,775,964; 4,041,692; 4,370,068; 4,803,672; 4,920,524; 5,228,013; 5,526,327; 5,818,798; 5,896,348; 6,256,265; 6,526,000; 6,628,571; 6,683,822; 6,882,597; 7,079,452; and D515,961. However, none of the creative methods disclosed in these prior art disclosures seem to have become significant in their adoption.

The present invention provides a means for displaying time which is a viable alternative to either analog or digit-based means currently in widespread use.

### SUMMARY OF THE INVENTION

The present invention provides display means useful for communicating information concerning time of day. A display according to the invention comprises: a background field having a total surface area, and a set of twelve hours indicators locations disposed on said background field. The hours indicators locations are arranged to be disposed substantially in a first single row on the background field, and each of the hours indicators locations are adapted to include an hours indicator. There is a set of eleven minutes indicators locations disposed on the background field, and the minutes indicators locations are arranged to be disposed substantially in a second single row on the background field. Each of the minutes indicators locations are adapted to include a minutes indicator.

The invention also includes a process for displaying the time of day which comprises the steps of: a) providing a display means which comprises: i) a background field having a total surface area; ii) a set of twelve hours indicators locations disposed on the background field, wherein the hours indicators locations are arranged to be disposed substantially in a first single row on the background field, and wherein each of the hours indicators locations are adapted to include an hours indicator; and iii) a set of eleven minutes indicators locations disposed on the background field, wherein the minutes indicators locations are arranged to be disposed substantially in a second single row on the background field, and wherein each of the minutes indicators locations are adapted to include a minutes indicator; and b) causing successive minutes indicators to have their perceivable visual character altered as a function of time.

### BRIEF DESCRIPTION OF THE DRAWINGS

FIG. 1 shows a frontal view of a display means according to one embodiment of the present invention;

FIG. 2A shows a frontal view of a display means according to one embodiment of the present invention;

FIG. 2B shows a frontal view of a display means according to one embodiment of the present invention;

FIG. 2C shows a frontal view of a display means according to one embodiment of the present invention;

FIG. 2D shows the display of the time of day 9:15 according to one embodiment of the present invention;

FIG. 2E shows the display of the time of day 8:30 according to one embodiment of the present invention;

FIG. 3 shows a frontal view of a display means according to an alternate embodiment of the present invention;

FIG. 4 shows a frontal view of a display means according to an alternate embodiment of the present invention;

FIG. 5A shows a frontal view of a display means according to an alternate embodiment of the present invention;

FIG. 5B shows a frontal view of a display means according to an alternate embodiment of the present invention; and

FIG. 6 shows a frontal view of a display means according to an alternate embodiment of the present invention.

### DETAILED DESCRIPTION

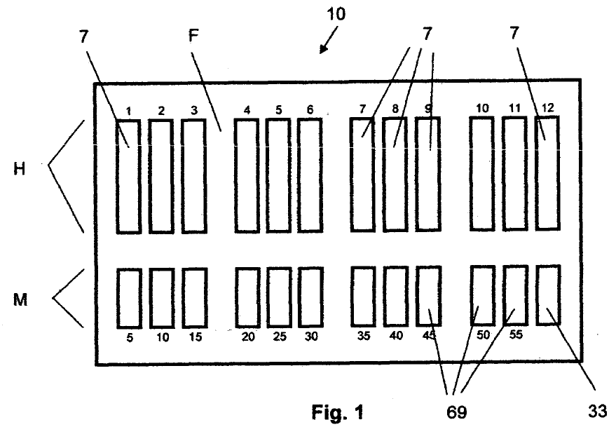

Referring to the drawings and initially to FIG. 1 there is shown a frontal view of a display means 10 according to one embodiment of the present invention. The display means 10 of FIG. 1 includes a field F upon which are disposed an hours row H of hours indicators 7, and a minutes row M of minutes indicators 69 and an optional dummy indicator 33 which does not contain an active time-indicating element. Thus, it is seen that there are twelve hours indicators 7 and eleven minutes indicators 69 and one optional dummy indicator 33, which collectively comprise two rows having twelve indicators in each row. Each of the hours indicators 7 are disposed at an hours indicator location, and each of the minute indicators 69 are disposed at a minutes indicators location.

According to one preferred embodiment, the hours indicators and minutes indicators are optionally arranged in groups of three within their respective rows, which arrangement can be useful in facilitating the reading of such a display means 10 by enabling a quicker conceptualization of the time of day displayed by the display means 10 than possible in the absence of such grouping.

The way in which a display means according to the present invention displays time is by indicating the hours and minutes, just as in conventional time display means.

The hours row H containing the hours indicators 7 preferably comprises a means for selectively altering the color, shade, brightness, contrast, or other perceivable visual aspect of any one or more given hours indicators 7 with respect to both the background field F and other hours indicators which are themselves desired, at a particular time, to not be of altered perceivable visual character. Thus, each of the hours indicators 7 of a display means 10 according to the invention are selectably alterable with regards to a visual aspect that is perceivable by an ordinary person who casually glances at the display means 10. Thus, in one embodiment, the hours indicator 7 having the numeral “1” above it in FIG. 1 may comprise a liquid crystal or LED display, which when energized causes that particular hours indicator to become visually changed sufficiently for a reader to notice that it is of a color, shade, brightness, contrast, etc. which is different from that of the field F and other hours indicators and minutes indicators. The changing of a perceivable visual aspect of a given hours or minutes indicator may also be accomplished by causing mere illumination, say, of any of the hours indicators 7 in FIG. 1 with respect to the field F.

In FIG. 1 the hours indicators 7 all have Arabic numerals above them in the range of 1 through 12, and the minutes indicators 69 all have Arabic numerals beneath them in the range of five through 55, stepped in increments of five. These numerals may or may not be present on a display 10 according to the invention in actual practice, as their presence in one embodiment is a matter of convenience.

Time is communicated using a display 10 according to the invention in hours and minutes. The hours are displayed by the hours indicators 7. For example, causing those particular hours indicators having the Arabic numerals 1, 2, 3, 4, 5, and 6 above them in FIG. 1 to have a different perceivable visual character than the remaining hours indicators in the hours row H and the field F is one means for indicating the sixth hour of the day. In an alternate embodiment of displaying the sixth hour of the day, only the particular hours indicator having the Arabic numeral six above it in FIG. 1 is caused to have a different perceivable visual character than the remaining hours indicators in the hours row H and the field F is also a means for indicating the sixth hour of the day.

By similar fashion, any hour of the day may be indicated by a display means 10 according to the invention.

The minutes are displayed by the minutes indicators 69. For example, causing those particular minutes indicators having the Arabic numerals 5, 10, and 15 beneath them in FIG. 1 to have a different perceivable visual character than the remaining minutes indicators in the minutes row M and the field F is one means for indicating fifteen minutes past the hour.

An alternate embodiment for displaying fifteen minutes past the hour may be carried out by causing only the particular minutes indicator having the Arabic numeral fifteen beneath it in FIG. 1 to have a different perceivable visual character than the remaining minutes indicators in the hours row M and the field F is also a means for indicating fifteen minutes past the hour.

By similar fashion, any minutes of the hour may be indicated by a display means 10 according to the invention. The display of the hours of the day, and minutes of the hour as aforesaid, can be collectively be employed to display any time of day to a viewer, to an accuracy within the nearest five minutes. That is, in addition to displaying the hour, a time display means 10 according to the invention can display times which are five, 10, 15, 20, 25, 30, 35, 40, 45, 50, and 55 minutes past the hour. The twelfth minutes indicator 33 in the minutes row M serves a redundant function, since it indicates a time which is sixty minutes past the hour, which is congruent to the display of the next hour using the hour indicator(s) alone. When the minutes indicator 33 is included, it is done so optionally, and may be included for aesthetic effects, so as to provide balance by providing a display means 10 having twelve indicators in each of the hours row H and minutes row M, which may have better eye appeal than a display means 10 having twelve indicators in the hours row H and only eleven indicators in the minutes row M. In one embodiment, the dummy indicator 33 flashes on and off in its contrast against the remainder of the display. It and all other minutes indicators, hours indicators and field elements of the display may flash once every second, or to any other desired rhythm.

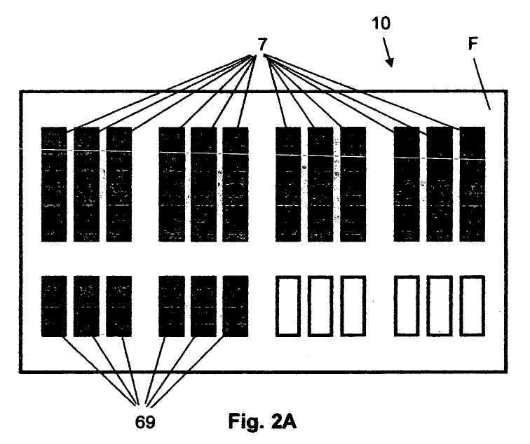

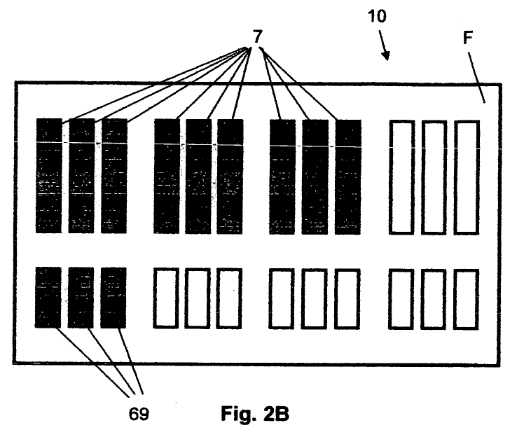

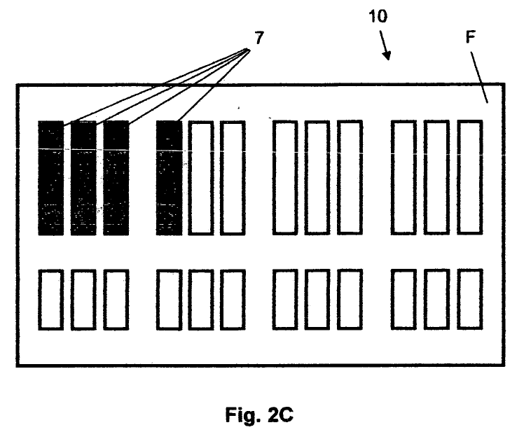

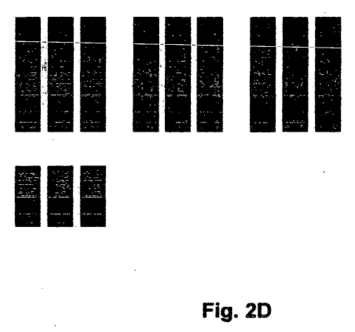

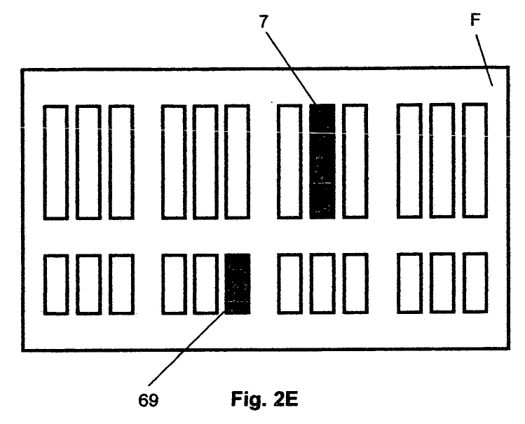

FIG. 2A shows a frontal view of a display means according to one embodiment of the present invention, in which the time 12:30 is displayed. In this FIG. 2A, all of the hours indicators 7 are caused to have a different perceivable visual character than the field F, thus indicating the twelfth hour. In accordance with what has been described in reference to FIG. 1, the first six minutes indicators have different perceivable visual character than the field F and the remaining minutes indicators, thus indicating thirty minutes past the hour. Similarly, FIG. 2B shows a frontal view of a display means according to an embodiment of the present invention in which the time 9:15 is displayed, by having the first nine hours indicators 7 having a different perceivable visual character than the remaining hours indicators 7 and the field F, and the first three minutes indicators having a different perceivable visual character than the remaining minutes indicators 69 and the field F. FIG. 2C shows a frontal view of a display means according to an embodiment of the present invention in which the time 4:00 is displayed, by having the first four hours indicators 7 having a different perceivable visual character than the remaining hours indicators 7 and the field F.

Thus, the hours indicators 7 and minutes indicators 69 are seen to preferably have, at different times, different perceivable visual characters, which may relate to color, shade, brightness, contrast, or other observable properties of these elements, with respect to one another and the field F. For purposes of illustration, such might include, without limitation, the shaded hours and minutes indicators in FIG. 2B being dark grey in color, while the un-shaded hours and minutes indicators comprise a lighter shade of grey, whilst the field F is white. In another embodiment, the shaded hours and minutes indicators in FIG. 2B may be yellow in color, while the un-shaded hours and minutes indicators are white, and the field F is black. In another embodiment, the field F is white and the hours and minutes indicators are red in color and the un-used hours and minutes indicators are not visible. In such embodiment, the time of day may be represented according to a system of the invention merely by the presence of hours and minutes indicators, as in FIG. 2D, in which the representation of the time of day 9:15 is depicted.

According to one embodiment of the invention, as time passes, beginning at the top of the hour of one o-clock, the only indicator which is distinctly different from the remaining ones and the field F is the hours indicator having the numeral “1” above it in FIG. 1. After the passage of five minutes, the minutes indicator having the “5” beneath it becomes altered in appearance, to also become visibly distinct from the field F and thus readable, which may or may not match in appearance that of the hours indicator having the numeral “1” above it. For example, the hours indicators could be gray, yellow, blue, red, green, or any other color when energized or otherwise caused to have a different perceivable visual character, and the minutes indicators could become yellow, red, blue, or any other color as they are caused to have a different perceivable visual character. In one embodiment, each of the hours indicators 7 are of different color than one another when energized. In one embodiment, each of the minutes indicators 69 are of different color than one another when energized, which may or may not be the same colors, shades, etc. of the hours indicators 7.

With the passage of another five minutes, the minutes indicator having the numeral “10” beneath it becomes altered in appearance, to also become visibly distinct from the field F, just as the minutes indicator having the “5” beneath it and the hours indicator having the “1” above it in FIG. 1 had. The illumination or change of visual character of successive minutes indicators proceeds in step-wise fashion with the passage of five minute intervals, until the one having the numeral 55 beneath it becomes distinguishable. Then, the passage of five more minutes may, in one embodiment cause the minutes indicator 33 of FIG. 1 to become altered in visual character, thus having all minutes indicators being visually distinguishable from the field F. In another embodiment, with the passage of the sixtieth minute, all of the minutes indicators go blank, i.e., they once again blend in with the field F and are visually indistinguishable therefrom or are otherwise indicated as being de-energized or inactivated, such as shown in FIGS. 2A-2C, in which the inactivated hours and minutes indicators are shown as empty boxes, with the “empty” placeholder boxes being present but not having their interior activated so as to convey information concerning the time. After the passage of the sixtieth minute in the foregoing description, the hours indicator 7 having the numeral “2” in FIG. 1 becomes altered in appearance, to also become visibly distinct from the field F. The hours indicator 7 having the numeral 1 above it may remain of distinct visual character from the field F, or it may be rendered indistinguishable therefrom, excepting or not its placeholder box, if present, since conveyance of the hours of the time of day according to the invention depends on indication of the current hour and minute. For example, FIG. 2E depicts the display of the time of day of 8:30 according to one embodiment of the present invention, which shows that only the indication of the current hour, indicated by the hours indicator 7 corresponding to that from FIG. 1 having the numeral “8” above it is visually distinct from the field F, and its minutes indicator 69 corresponding to that having the minutes indicator “30” beneath it in FIG. 1 is visually distinct (different perceivable visual character) from the field F, thus depicting 8:30. In an alternate embodiment, all of the hours indicators to the left of the one at the eight o'clock position which is shaded could be of identical visual appearance to that of the one at the eight o'clock position, and thus distinct from the field F. Alternatively, all of the hours indicators to the left of the one at the eight o'clock position which is shaded could be of different visual appearance to that of the one at the eight o'clock position, but still be distinct from the field F and thus indicate the eight hour of the day. Similarly, all of the minutes indicators to the left of the one at the thirty minute position which is shaded could be of identical visual appearance to that of the one at the thirty minutes position, and thus distinct from the field F. Alternatively, all of the minutes indicators to the left of the one at the thirty minutes position which is shaded could be of different visual appearance to that of the one at the thirty minutes position, but still be distinct from the field F and thus indicate the thirtieth minute of the hour.

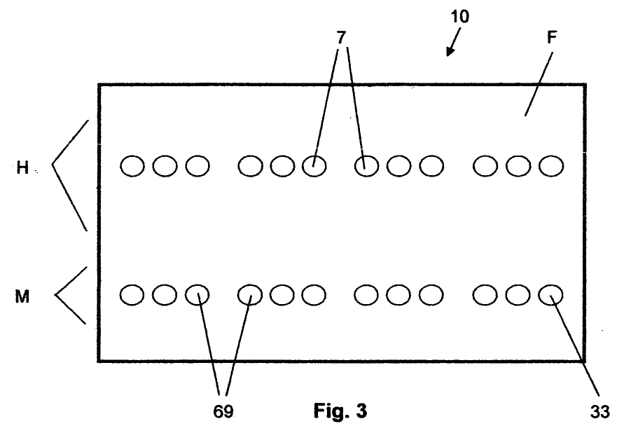

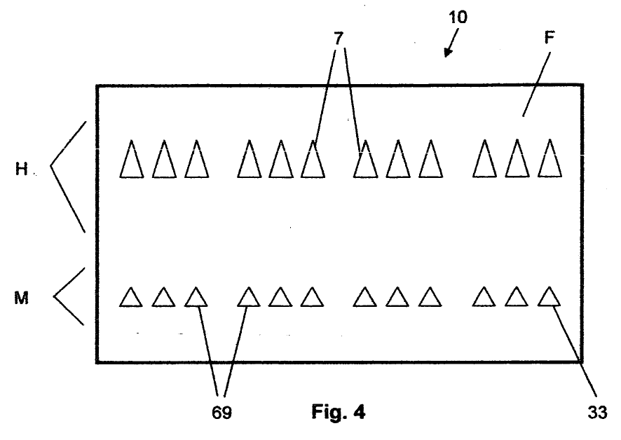

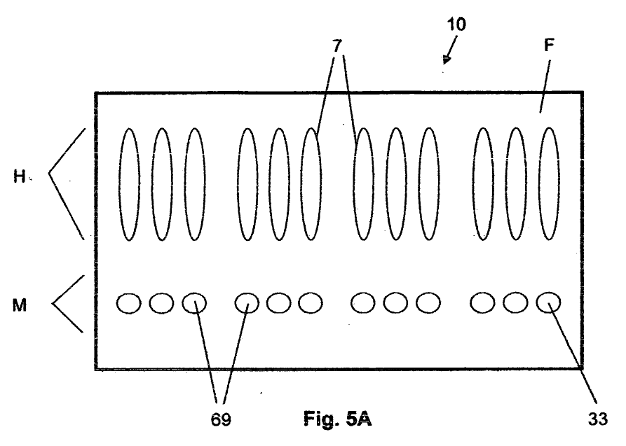

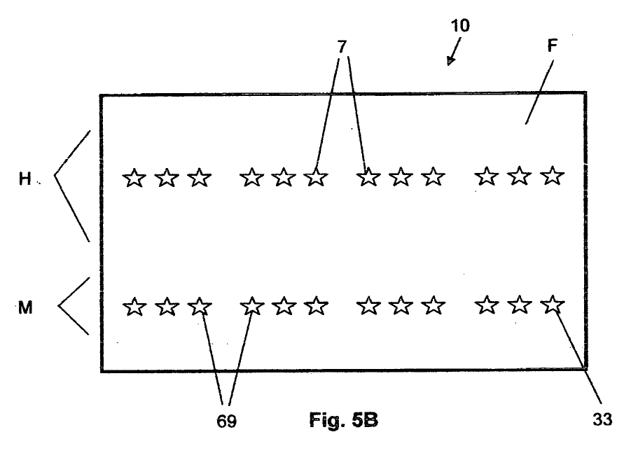

Although the display means 10 described so far have included hours indicators 7 and minutes indicators 69 which are substantially rectangular in configuration, it is entirely within the scope of the present invention to employ hours indicators 7 and minutes indicators 69 which are of any one of literally thousands of possible geometric shapes. The shapes used for the hours indicators 7 may be the same shape as those used for the minutes indicators 69, or they may be different from one another. For example, in FIG. 3 shows a frontal view of a display means 10 according to an alternate embodiment of the present invention in which the hours indicators 7 and minutes indicators 69 are circular in shape. In FIG. 4 is shown a frontal view of a display means 10 according to an alternate embodiment of the present invention in which the hours indicators 7 and minutes indicators 69 are triangular in shape.. In FIG. 5A is shown a frontal view of a display means 10 according to an alternate embodiment of the present invention in which the hours indicators 7 are oval in shape and the minutes indicators 69 are circular in shape. In FIG. 5B is shown a frontal view of a display means 10 according to an alternate embodiment of the present invention in which the hours indicators 7 and the minutes indicators 69 are both shaped as stars.

The present invention includes hours indicators 7 and minutes indicators 69 which exist in any shape, including without limitation the shapes of circles; rectangles; polygons having between four and twenty-four sides; facsimiles of animals; household items such as vases, clocks; sporting items including balls and sports logos; boats; automobiles; symbols; animated characters; wearing apparel; and jewelry, as examples which are illustrative and not delimitive of the invention.

In the various figures herein, the hours indicators 7 and minutes indicators 69 are each depicted as being substantially the same size as one another, as concerns the surface area each occupies with respect to the total surface area of the field F. It should be noted that the present invention includes the embodiments wherein each of he hours indicators 7 occupy more surface area than the minutes indicators 69, as well as embodiments wherein each of he hours indicators 7 occupy less surface area than the minutes indicators 69, either on an individual or a collective basis. This is the case whether the row of hours indicators 7 is above or below the row of minutes indicators 69 in the display means 10. even though the figures show only specific instances in which the row of minutes indicators 69 are below the row of hours indicators 7.

In one embodiment, a display means according to the invention may also exist in the form of a billboard, having a white or other light-colored or translucent field, and clear planar pockets, sleeves or envelopes attached to the face of such billboard which are capable of receiving a minutes indicator or an hours indicator, which minutes or hours indicators may be in the form of red or other colored pieces of paper, cardboard, polyethylene sheet etc., (sufficient to contrast with the billboard) which are placed by a workman into the pockets, sleeves or envelopes at locations through slots in the bill board, or openings at the top of the pockets, sleeves, or envelopes, or alternatively hung on hooks attached to the face of the billboard. While not the most efficient or desirable means of using a system for displaying time according to the present invention, such embodiments are nevertheless illustrative of the invention and its widespread applicability and adaptability.

End use appliances comprising a display means for time according to the present invention include wall clocks having the two rows of indicator means as herein described. A system of displaying time according to the present invention may be readily incorporated into time displays in automobiles, and on computer screens, for example. Although shown in FIG. 1 as being enclosed within a rectangular border or frame, a display means 10 for showing time of day according to the invention need not necessarily have a border or frame, as shown in FIG. 2D.

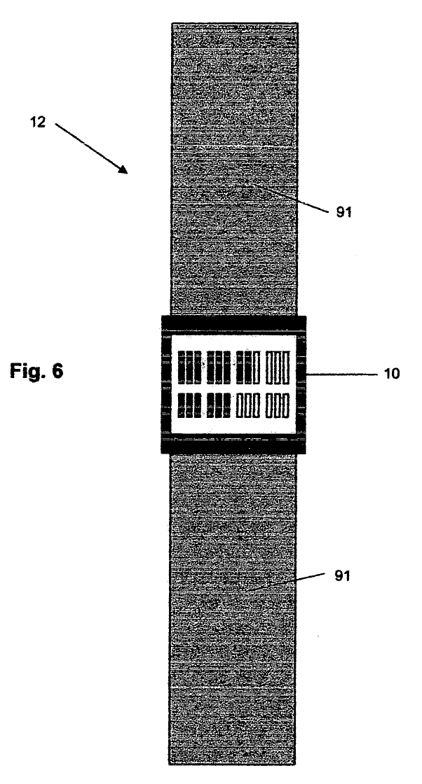

An additional embodiment in FIG. 6 shows a wristwatch 12 having a display 10 according to the present invention on its face, which further comprises a watchband 91 attached thereto. This fulfills one object of the invention, which is to provide a wristwatch having the display means herein described in the place of a conventional analog or digital time display means.

A display means for showing time of day has been described with reference to a billboard, to which a workman physically attaches dark pieces of cardboard or other material in the positions indicated in this specification which correspond to various times of day, in five-minute incrementals. While such means is useful for conveying information concerning the passage of time, and while such means is also useful for wall clocks and wristwatches etc., it may in other cases be desirable to employ automated electronic means to cause changes in the visual appearance of a display means 10 provided in accordance with the present invention. The prior art is replete with quartz-controlled and other electronic circuitry capable of causing changes in the appearance of time displays with the passage of time, and many such means well-known in the art are useful in providing a display means 10 according to the present invention. These include, without limitation, the circuitry disclosed (and referenced within) U.S. Pat. Nos. 4,396,295; 5,636,185; 6,256,265; and 7,079,452 all of which are herein incorporated by reference thereto. For embodiments in which electronic means are employed to cause a change in perceivable visual character of the elements of a display 10 according to the invention in accordance with this specification, as time passes, successive minutes indicators 69 are caused to be changed in their visual character, as previously described, until the passage of the next successive hour has elapsed, at which time the visual character of the next successive hours indicator 7 is visibly altered. This process continues throughout the day, with the display 10 having a different appearance for each five minute interval in every twelve hours of time. Thus, it is in accordance with the invention that successive minutes indicators and hours indicators are caused to have their perceivable visual character altered as a function of time, with the minutes indicators 69 changing after the passage of every five minutes, and with the hours indicators 7 changing every hour.

It is clear to one of ordinary skill after reading the instant specification, that the minutes indicators 69 are successively caused to change appearance with the passage of five minute intervals as herein described, and that the hours indicators 7 are successively caused to change appearance with the passage of the hours intervals as also described herein. Since no Arabic characters are involved typically in displaying time according to the present invention, implementation of electronic means to provide a display of time as herein specified is more simple than prior art means which display Arabic numerals.

Consideration must be given to the fact that although this invention has been described and disclosed in relation to certain preferred embodiments, obvious equivalent modifications and alterations thereof will become apparent to one of ordinary skill in this art upon reading and understanding this specification and the claims appended hereto. This includes rotation of a display means, so that what have been described herein as rows become effectively columns, and it is entirely within the scope of the present invention to provide a display as described herein as comprising two columns of indicators instead of two rows. Within such context, rows and columns would be equivalent. This further includes subject matter defined by any combination of any one of the various claims appended hereto with any one or more of the remaining claims, including the incorporation of the features and/or limitations of any dependent claim, singly or in combination with features and/or limitations of any one or more of the other dependent claims, with features and/or limitations of any one or more of the independent claims, with the remaining dependent claims in their original text being read and applied to any independent claims so modified. This also includes combination of the features and/or limitations of one or more of the independent claims with features and/or limitations of another independent claims to arrive at a modified independent claim, with the remaining dependent claims in their original text being read and applied to any independent claim so modified. The present specification hereby expressly includes all embodiments in which all forms of the infinitive word “comprising” is replaced by either or both of “consisting of” and “consisting essentially of”, standing as originally specified herein, and as modified per the foregoing. Accordingly, the presently disclosed invention is intended to cover all such modifications and alterations.

I claim:

1) A display means useful for communicating information concerning time of day, which comprises:
a) a background field having a total surface area;
b) a set of twelve hours indicators locations disposed on said background field, wherein said hours indicators locations are arranged to be disposed substantially in a first single row on said background field, and wherein each of said hours indicators locations are adapted to include an hours indicator;
c) a set of eleven minutes indicators locations disposed on said background field, wherein said minutes indicators locations are arranged to be disposed substantially in a second single row on said background field, and wherein each of said minutes indicators locations are adapted to include a minutes indicator.

2) A display according to claim 1 wherein said hours indicators locations include a means for causing a change in their visual character that is perceivable with the human eye.

3) A display according to claim 2 wherein said hours indicators locations each include an hours indicator which is selected from the group consisting of: light emitting diodes, and liquid crystal displays.

4) A display according to claim 1 wherein said minutes indicators locations include a means for causing a change in their visual character that is perceivable with the human eye.

5) A display according to claim 4 wherein said minutes indicators locations each include a minutes indicator which is selected from the group consisting of: light emitting diodes and liquid crystal displays.

6) A display means according to claim 1 wherein said field is substantially rectangularly shaped.

7) A display means according to claim 1 wherein said hours indicators are shaped substantially in a shape selected from the group consisting of: rectangles, triangles, circles, ovals, and stars.

8) A display means according to claim 1 wherein said hours indicators are shaped substantially in a shape selected from the group consisting of: rectangles, triangles, circles, ovals, and stars.

9) A display means according to claim 1 wherein the hours indicators and the minutes indicators are substantially the same size of one another, as adjudged by their respective surface areas against said background field.

10) A display means according to claim 1 wherein the hours indicators occupy substantially more surface area of the background field than do the minutes indicators.

11) A display means according to claim 1 wherein the minutes indicators occupy substantially less surface area of the background field than do the minutes indicators.

12) A display means according to claim 1, which further comprises a twelfth minutes indicators location, said twelfth minutes indicator location being disposed in said second single row on said background field.

13) A display means according to claim 12 wherein said twelfth minutes indicators location does not contain an active time-indicating element.

14) A display means according to claim 12 wherein the visual appearance of said twelfth minutes indicators location alters once with the passage of each second.

15) A process for displaying the time of day which comprises:
a) providing a display means which comprises:
i) a background field having a total surface area;
ii) a set of twelve hours indicators locations disposed on said background field, wherein said hours indicators locations are arranged to be disposed substantially in a first single row on said background field, and wherein each of said hours indicators locations are adapted to include an hours indicator; and
iii) a set of eleven minutes indicators locations disposed on said background field, wherein said minutes indicators locations are arranged to be disposed substantially in a second single row on said background field, and wherein each of said minutes indicators locations are adapted to include a minutes indicator; and
b) causing successive minutes indicators to have their perceivable visual character altered as a function of time.

16) A process according to claim 15 wherein the perceivable visual character of said minutes indicators changes at the passage of every five minute interval.
